(19) United States
(12) Patent Application Publication
(10) Pub. No.: US 2007/0266811 A1
(43) Pub. Date: Nov. 22, 2007

(54) Planet wheel with a hard metal pin produced in a powder-metallurgical process

(75) Inventor: Heinz Gert Hagedorn, Rottweil (DE)

Correspondence Address: NATH & ASSOCIATES, 112 South West Street, Alexandria, VA, 22314, US

(73) Assignee: IMS GEAR GmbH, Eisenbach (DE)

(21) Appl. No.: 11/798,545

(22) Filed: May 15, 2007

(30) Foreign Application Priority Data
May 17, 2006 (DE) 10 2006 023 390.5

(51) Int. Cl. F16H 57/02

(52) U.S. Cl. 74/412 R

(57) ABSTRACT

The invention relates to a revolving toothed gear with at least two meshing gearwheels, one of which is a gearwheel that turns by means of a sliding joint and is mounted on a pin in a manner that permits rotation. To this end, the pin is a hard metal pin.

The present invention increases the operating life of the gearwheel.

The invention relates to a revolving toothed gear with at least two meshing gearwheels, one of which is a revolving gearwheel that is mounted on a pin.

Revolving toothed gears are, e.g., planetary gears. The revolving wheels, the planetary wheels, are mounted on pins. The use of needle bearings in mounting the planetary wheels on pins requires a large diameter for the planetary wheel and thus a large diameter for the entire planetary gear. The minimum structural size of such a planetary gear is thus determined not only by the transmitted power but also the structural space occupied by the needle bearings. A consequence is that planetary gears of this kind are often oversized.

When the planetary gear is designed so as to employ a plain bearing between the planetary wheel and the pin, a problem consists in ensuring that the bearing is sufficiently lubricated.

Operating the planetary gear with, e.g., a commutating motor may result in torque fluctuations on the drive side. In the sliding joint, these fluctuations bring about changes in the sliding speed of the sliding partner. For some pins, e.g., those produced from roller bearing steel, this may result in heavy wear and may thus lead to the failure of the planetary gear. Tests with pins of aluminum peroxide ceramic have not yielded a satisfying outcome. Such pins have a high degree of hardness, but tend to fracture when there are fluctuations in the load.

The aim of the present invention, therefore, is to increase the operating life of the rotating toothed gear and, in the process, particularly to improve its fracture behavior.

This aim is achieved with the features of the primary claim. The pin is accordingly a hard metal pin. Its bending strength is ideally greater than 2500 N/mm².

A pin of hard metal has a hardness that is comparable to that of aluminum oxide ceramic. This hardness is considerable higher than the hardness of a roller bearing steel. Compared with aluminum oxide ceramic, however, hard metal has a higher elastic modulus and greater ductility. The greater toughness of hard metal as compared to aluminum oxide ceramic, in conjunction with the greater hardness of the material, allows the individual sliding bearing to operate with greater resistance to wear and thus gives the planetary gear a longer operating life.

Further details of the invention emerge in the secondary claims and from the following description of embodiment, which is schematically depicted.

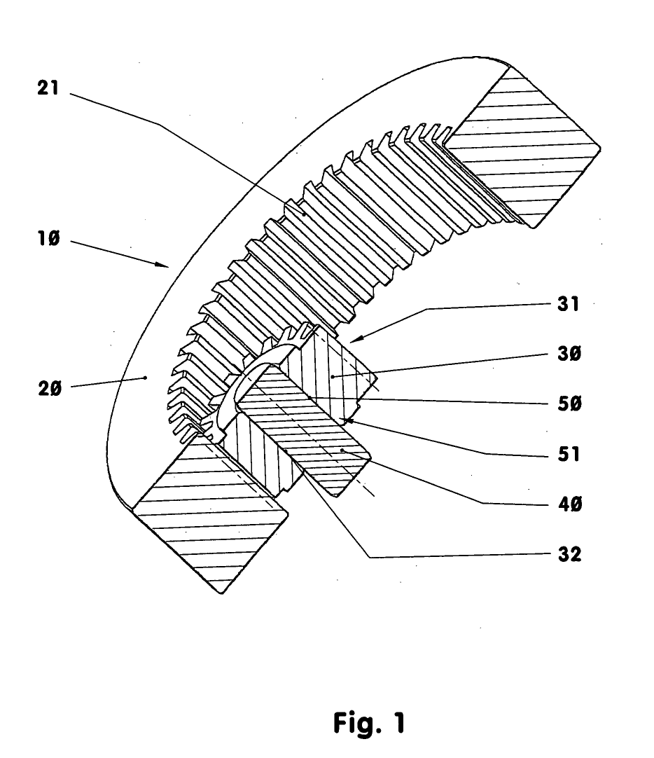

FIG. 1: Planetary Gear

FIG. 1 shows a ring gear 20 and a planet wheel 30, which meshes with it. These are parts of a spur-wheel planetary gear 10. The planetary gear 10 comprises, e.g., a ring gear 20, three planet wheels 30, a planet carrier, and a sun wheel. The ring gear 20, the planet carrier, and the sun wheel are, e.g., coaxially positioned. The planet wheels 30 may be positioned in staggered fashion at 120 degrees over a shared arc, whose diameter is half the sum of the toothing arc of the ring gear 20 and of the sun wheel. In the exemplary embodiment, each planet wheel 30 is mounted on a central pin 40 in rotating fashion. The pins 40 are, e.g., permanently connected to the planet carrier.

The individual planet wheel is manufactured from, e.g., steel and is nitrided.

To receive the pin 40, the individual planet wheel 30 has a cylindrical through-hole 32, which is oriented in the longitudinal direction. The pin 40 has a cylindrical cross-section with a diameter of, e.g., 5 mm, at least in the area where the planet wheel is received.

The pin 40 consists of a hard metal. The hard metal is a compound material, consisting of hard material—e.g., tungsten carbide, tantalum carbide, titanium carbide, etc.—and of a binding agent, e.g., cobalt. In the exemplary embodiment, the hard metal pin 40 consists of 90.5% by weight tungsten carbide and 9.5% by weight cobalt. Other hard materials are not incorporated. The structure is non-reactive to foreign matter.

The portion of the hard material(s) in the work material can lie, e.g., between 70% and 94% by weight. The portion of the binding agent accordingly lies between 30% and 6% by weight.

For hard metals, the portion of hard material determines the hardness of the work material and the wear characteristics. The binding agent gives the compound material its toughness. Thus the hard metal pin 40 of the exemplary embodiment has a high degree of hardness, e.g., 1230 HV, and a high toughness.

In the exemplary embodiment, the employed grain size of the hard metal pin 40 is 8 micrometers. The hard metal pin 40 thus has a density of 14,500 kg/m³. It reaches a bending strength of at least 2000 N/mm², ideally greater than 2800 N/mm², and a compressive strength of 3800 N/mm².

If the hard metal pin 40 should have a high thermal resistance, it may exhibit, in addition to the hard tungsten carbide, a portion of titanium carbide of up to 12% by weight. This reduces the effect of the binding agent, however, which in turn reduces the toughness.

The use of, e.g. tantalum carbide has a smaller influence on the effect of the binding agent. This hard material can accompany tungsten carbide in a portion of up to 8% by weight. This only slightly changes the effect of the binding agent, while simultaneously raising the toughness of the material. Operating safety is further enhanced as a result.

Through a combination of all three indicated hard materials and the binding agent the physical characteristics of the hard metal can be finely adjusted.

The hard metal pin 40 can also have surface coating. This might be, e.g., a thin layer of titanium carbide, titanium nitride, or titanium. The layer thickness is, e.g., between 5 and 15 micrometers. This coating is either separated from the gas phase in the so-called CVD process or produced in the PVD process by means of ions in an electrostatic field. Of the indicated coatings, those of titanium carbide and titanium carbide have the highest resistance to wear.

Upon assembly, the planet wheel 30 is pushed onto the pin 40. The pin 40 and the through-hole 32 have a loose fit. After assembly, the toothings 21, 31 are lubricated, e.g., with oil.

When the wheels 20, 30 turn, the planet wheel 30 rotates on the pin 40. These two parts 30, 40 form a radial sliding bearing 40 with a sliding mount 51.

During operation the through-hole 32 of the planet wheel 30 slides on the hard metal pin 40 in the circumferential direction. The through-hole 32 is subjected here to a circumferential load and the hard metal pin 40 to a lumped load. The lumped load on the hard metal pin 40 takes effect in the radial direction of the planetary gear 10. Because of its high hardness and high toughness, the surface of the hard metal pin 40 is resistant to the wear caused by this pressure load.

During operation of the planetary gear 10, changes in load from the output end (block travel) may occur in sudden bursts. Here there is a change in the ratio of the output torque to the driving torque of the planetary gear 10. The hard metal pin 40, which is resistant to bending, prevents the pin from cracking. In addition, the nitriding of at least the through-hole 32 (for example) contributes to the robust combination of materials in the sliding joint 51.

### LIST OF REFERENCE, NUMERALS

10 spur wheel planetary gear, revolving toothed gear
20 ring gear
21 toothing
30 revolving gearwheel, planet wheel
31 toothing
32 through-hole
40 pin, hard metal pin, bearing pin
50 radial sliding bearing
51 sliding joint

1. Revolving toothed gear with at least two meshing gearwheels, one of which is a revolving gearwheel mounted in rotating fashion on a pin by means of a bearing
wherein
the pin is a hard metal pin (40).

2. Revolving toothed gear according to claim 1,
wherein
the work material of the hard metal pin (40) consists of hard metal and a binding agent.

3. Revolving toothed gear according to claim 2,
wherein
the portion of the binding agent is greater than 9% by weight.

4. Revolving toothed gear according claim 2, wherein
the binding agent is cobalt.

5. Revolving toothed gear according to claim 2,
wherein
the hard metal is tungsten carbide.

6. Revolving toothed gear according to claim 4, wherein
the employed grain size of the hard metal is 8 micrometers.

7. Revolving toothed gear according to claim 6,
wherein
the structure of the hard metal pin (40) is non-reactive to foreign matter.

8. Revolving toothed gear according to claim 1,
wherein
the surface of the hard metal pin (40) is coated with a layer of titanium nitride or a layer of titanium carbide.

9. Revolving toothed gear according to claim 1,
wherein
at least the through-hole (32) which belongs to the revolving gearwheel (30) and which receives the hard metal pin (40) is nitrided.

10. Revolving toothed gear according to one of claims 1 to 9 claim 1,
wherein
the hard metal pin (40) has a bending strength that is greater than 2500 N/mm².

11. Revolving toothed gear according to claim 1,
wherein
the mounting is a sliding bearing or a roller bearing (needle bearing, ball bearing).

12. Revolving toothed gear according to claim 3,
wherein
the binding agent is cobalt.

13. Revolving toothed gear according to claim 5,
wherein
the employed grain size of the hard metal is 8 micrometers

14. Revolving toothed gear according to claim 2,
wherein
the hard metal pin (40) has a bending strength that is greater than 2500 N/mm².

15. Revolving toothed gear according to claim 3,
wherein
the hard metal pin (40) has a bending strength that is greater than 2500 N/mm².

16. Revolving toothed gear according to claim 4,
wherein
the hard metal pin (40) has a bending strength that is greater than 2500 N/mm².

17. Revolving toothed gear according to claim 5,
wherein
the hard metal pin (40) has a bending strength that is greater than 2500 N/mm².

18. Revolving toothed gear according to claim 2,
wherein
the mounting is a sliding bearing or a roller bearing (needle bearing, ball bearing).

19. Revolving toothed gear according to claim 3,
wherein
the mounting is a sliding bearing or a roller bearing (needle bearing, ball bearing).

20. Revolving toothed gear according to claim 4,
wherein
the mounting is a sliding bearing or a roller bearing (needle bearing, ball bearing).
